(19) United States
(12) Patent Application Publication
(10) Pub. No.: US 2013/0004684 A1
(43) Pub. Date: Jan. 3, 2013

(54) Method for manufacturing a marking and corresponding product

(75) Inventors: Tomi Erho, Espoo (FI); Soili Peltonen, Espoo (FI); Jouko Virtanen, Espoo (FI); Olli-Heikki Huttunen, Espoo (FI)

(73) Assignee: TEKNOLOGIAN TUTKIMUSKESKUS VTT, Espoo (FI)

(21) Appl. No.: 13/581,634

(22) PCT Filed: Mar. 3, 2011
(86) PCT No.: PCT/FI2011/050187

§ 371 Date: Sep. 20, 2012

(30) Foreign Application Priority Data
Mar. 5, 2010 (FI) 20105214

(51) Int. Cl. B41M 3/14; B32B 27/10; B05D 5/06

(52) U.S. Cl. 428/29; 427/162

(57) ABSTRACT

The invention relates to the production of an optically detectable marking on a substrate. In the method, a substrate is taken, a printing ink containing a starch derivative in a solution form is printed on at least a selected first area and at least a selected second area is left unprinted, the printing ink is allowed to dry, in such a way that the starch derivative form a thermoplastic film in the said first area on the surface of the substrate, and an optically detectable marking is hot-pressed into the film. The invention also relates to a corresponding product. With the aid of the invention hot-pressable diffractive embossing is created at low temperatures, for example, on paper or board.

The invention relates to thermoplastic biopolymer films and optical structures hot-pressed into them. In particular, the invention relates to a method for producing an optically detectable marking, as well as a paper or board product, in which there is such a marking.

Much work is being done world-wide to develop authenticity verification techniques for fibre-based products, such as product packages and cigarette papers, as well as to increase the attractiveness of a product or package. Cost-effective solutions are of great commercial importance, in terms of both brand-building and authenticity detection. These factors are emphasized in consumer-package products, as packages and products nowadays often travel globally before reaching the consumer.

At present, commercial authenticity detection applications are based on attaching a separate tape or sticker to the product. Methods are also known for producing optical structures, but the production of the optical structures requires synthetic varnishes or coatings, which are by no means suitable for all applications.

Techniques implemented in connection with the manufacture and/or printing of a product or package permit cost-effective ways of creating properties of the kind in question in products and packages. Markings implemented during manufacture are also more difficult to falsify than markings made afterwards (e.g., with the aid of sticker technology).

A starch-based paper, which comprises a thermoplastic coating pigment, is previously known from GB patent application 0725100.2 and FI patent application 20086080. The thermoplasticity of the pigment is exploited in the hot-pressing of optical lattices.

Publication WO 2009/080879 discloses a diffractive microstructure, which is produced in a coated paper. The coating substance comprises a starch derivative in a dispersion form.

Markings formed in connection with manufacture and/or printing have not yet achieved very great commercial use, due to, among other things, technical and cost reasons.

In the present invention, the idea of these patent applications is refined further, and a starch film of the desired shape is produced on the paper's surface by a printing technique exploiting a starch modificate with more optimal thermoplastic properties, instead of a pigment.

The invention is intended to create a new method for producing a marking on a substrate. In particular, the invention is intended to create a cost-effective method, which can be implemented at low temperatures.

In addition, the invention is intended to create a new product equipped with such a marking.

These objectives are achieved by means of the solutions according to the independent Claims.

According to one embodiment, in the present invention, any printing technique whatever (e.g., offset, gravure, flexography or serigraphy, inkjet) is utilized to produce a thermoplastic film on a base, at the desired location and of the desired shape. Printing is exploited by forming a starch-derived printing-ink solution with thermoplastic properties, from which a film with the desired shape is formed on the base. In the hot-pressing process, the optical structures are formed only on this film and not on the paper surrounding it.

In the invention, an optical identifier image is produced directly on the product, with the aid of a biopolymer, particularly of a starch derivative, and a hot-pressing technique.

The starch derivative can be, for example, starch acetate, preferably hydroxypropylized starch acetate or cationic starch acetate.

The identifier image, i.e. the marking, can comprise, for example, a diffractive image, such as a hologram. Such an image comprises microgrooves and/or microprotrusions in the starch-derivative film.

The identifier image is preferably detectable with the naked eye, i.e. visually. Of course, with the aid of the invention, mechanically optically detectable patterns can also be produced.

The substrate is typically paper or board. Thus, with the aid of the invention hot-pressable diffractive embossing can be created economically at low temperatures, for example, on paper or board.

In connection with the invention, it has been observed surprisingly that, by using a printing technique (here the term includes computer printing, particularly inkjet printing), a base can be created, which, in its hot-pressability, is equal to, or even better than a coating technique, if a starch derivative is applied is the form of a solution. In addition, it has been observed that the film created is of a considerably higher quality when hot-pressed, than a film formed from a pigment-form starch.

Thus, considerable advantages are gained with the aid of the invention. A combination of the present material and application technique will make the introduction of the use of the present marking technique, to be performed during manufacture, significantly easier and more attractive. Using the method, it is possible, for example, in printing or paper-processing plants, to surface treat different types on papers and packages normally used in printing, without requiring specially coated paper.

By using a printing-ink solution based on a thermoplastic biopolymer, a film surface, on which the desired optical image can be produced by hot-pressing, can be formed on various types of fibre-based products. By exploiting a printing technique, the film can be made into a surface with a desired shape and on only the desired area.

The invention differs from the technique disclosed in patent application GB 0725100.2, for example, in that, among other things, in the latter a specially coated paper is used, in which the coating can contain a carbohydrate polymer.

In the technique disclosed in patent application FI 20086080, on the other hand, a starch pigment in a printing-ink formulation is used, which has, however, been found to be a more expensive technique and to produce optical patterns of a poorer quality than the technique according to the present invention. In the invention, the starch is in a (non-pigment) solution form. Therefore, due to the thermoplastic properties of the modified starches depicted in the invention, an optical structure can be produced at considerably lower process temperatures than in the case of a starch pigment. According to the present invention, a lattice pattern can be reproduced already at a temperature of about 90° C. in static compression, and at slow roll-to-roll running speeds of up to 20 m/min, and, at a temperature of 120-130° C., at a running speed of as high as 80 m/min. In addition, the optical structure is visually more efficient, i.e. can be seen more clearly and has a pleasanter appearance.

Compared to the dispersion form disclosed in publication WO 2009/080879, the solution form according to the present invention offers considerably better applicability with various printing techniques. Particularly its roll-to-roll printing properties are considerably better. This is an essential difference in terms of industrial implementability, because it is much simpler and easier to use a printing press to add a starch surface only to the necessary locations, instead of making a special paper solely for this purpose. In addition, by patterning using printing, if wished, the desired lattice pattern is obtained on a specific area of the desired shape on the surface of the paper, which increases use applications considerably, compared to coating techniques.

A dispersion form rather than a solution form will usually be required, especially if the degree of acetylization is raised to be high, when solubility in water will disappear. However, a dispersion can still be made from even hydrophobic polymers. However, this solution is not included in the scope of the Claims of the present application, but can act as a basis for divided applications, solely or jointly with the embodiments described in the application.

The manufacturing costs of the starch derivatives used in the invention are also competitive with those of starch pigments produced by the dissolution-precipitation technique.

The printing technique described in the invention permits areas of a desired shape to be created on many different types of fibre-based printing bases, thus increasing the number of possible applications. As the area, in which optical structures can be made by hot-pressing, is formed locally by a printing technique, the same hot-pressing roller can be used to pattern several different types of product, e.g., with the same brand's optical image. Fibre-based products intended as applications are usually printed by multi-colour printing, the equipment used for which can be, as such, used to add a starch film with the aid of the invention.

The bio-basis of the identifier permits its use in, e.g., the foodstuffs and tobacco industries.

The following describes in greater detail embodiments of the invention and their advantages.

According to one embodiment, the method according to the invention comprises
providing a paper or board substrate is taken,
printing a starch derivative in a solution form containing printing ink is on the substrate's surface in at least a selected first area, at least a selected second area being left unprinted,
drying the printing ink in such a way that the starch derivative forms a thermoplastic film in the said first area on the surface of the substrate,
hot-pressing an optically detectable marking onto the film in static compression (e.g., plate hot-pressing) or in roll-to-roll compression.

In the invention, the hot-pressing technique disclosed in patent applications GB 0725100.2 and FI 20086080 can be exploited, as can the starch modificates referred to in publication WO 2008145827. In the technique described in the relevant patent applications, for example, hydrophobic starch esters, with a DS of at least 1.7, more particularly 1.7-3, or cellulose derivatives analogous to the starch derivatives, are used as the thermoplastic starch material. From these, a coating paste or printing ink is created, which forms a film on the paper's surface, in which permanent optical structures can be hot-pressed with the aid of temperature (typically >100° C.) and pressure (several MPas, especially >2 MPa). The optical structures can be designed to be purely decorative, or suitable for the visual detection of authenticity.

The drying of the printing ink can be passive or active. The term “to dry” includes both alternatives. Active drying will accelerate further processing of the substrate. In further processing, rolling of the substrate, for example, can be an intermediate state before hot-pressing, when the film should be also essentially dry. Active drying can comprise, for example, air drying or infra-red drying.

As the above description shows, according to the present invention, the surface properties of the fibre products are altered by treating the surface with a starch modificate. This is spread on at least one side of the fibre product, when the application amount will suffice to form a unified film on the surface of the fibre product.

The term starch modificate refers to a starch derivative (polymer) obtained from starch mainly by chemical processing. The most suitable for use in the invention are starch derivatives, the affinity of which with the fibre substrate, printing ink, printing-ink solvent, or some combination of these is altered and improved. A starch derivative, which contains structures that increases its hydrophilic or hydrophobic nature, is typically used in the invention. Starch modificates incorporating both hydrophilic and hydrophobic structures (e.g., hydroxypropyl and acetate groups) can also be used. As a result of modification, a starch modificate will adhere well to the surface of a fibre product and be able to form a hot-pressable film.

The starch modificate can be cationic, anionic, or non-ionic. This product is applied in small amounts to the surface of the fibre product from a solution, for which reason starch modificates, i.e. derivatives, from which printable solutions can be made, are suitable for use.

It should be stated that, as a result of the modification described above, a starch modificate is usually more easily dissolved in water than a starch, which facilitates its application from a dilute water phase.

Starch esters, starch ethers, and starch ester-ethers are examples of starch modificates worth mentioning as being especially suitable for the invention. The following are particularly advantageous examples: anionic alkenylsuccinate of starch, non-ionic hydroxypropyl starch, anionic carboxymethyl starch, non-ionic hydroxypropylized starch ester, such as hydroxypropylzed starch acetate, starch acetate, cationic starch, cationic starch ester, such as cationic starch acetate, as well as mixtures of these.

In the composition according to the invention, starch or its derivative, from which a starch modificate is formed, can be based on any natural starch whatever (a native starch), the amylose content of which is 0-100% and the amylopectin content of which is 100-0%. Thus, the starch component can come from barley, potatoes, wheat, oats, peas, maize, tapioca, sago, rice, or similar tuber or grain plants. It can also be based on starches manufactured from the said natural starches by oxidizing, hydrolyzing, cross-linking, cationizing, grafting, etherifying, or esterifying.

According to a first embodiment, a starch ester is used as the starch modificate, e.g., carboxy-lower alkyl-starch, or hydroxy-lower alkyl-starch, in which the lower alkyl group is methyl, ethyl, n- or i-propyl, or n-, i-, or t-butyl. Carboxymethyl starch and hydroxypropyl starch are two possible examples.

A starch modificate of this kind can be manufactured, e.g., by hydroxyalkylizing a starch to a preselected degree of molecular substitution. The manufacture of hydroxypropyl ethers is described in, for example, US patent publication 3,033,853 or Finnish patent FI 107930.

Optionally, the hydroxypropyl ethers are esterified after this. Esterifying can be performed in a manner that is, as such, known (see, for example, FI patent publication 107930). According to a preferred embodiment, acetylized hydroxypropyl starch is used, which can be made from hydroxypropyl starch, by making this react with acetic anhydride.

The degree of molecular substitution (MS) of the hydroxyalkylized starch esters can be 0.05-4 and the degree of substitution (DS) of the ester groups can be 0-3. According to one embodiment, hydroxypropyl starch acetate is used, the MS of which is typically 0.05-2 and the DS is 0.3-3. It can be stated generally that, if the DS is 3 or greater, and the degree of hydroxypropylization is low, the product will not be water-soluble, in which case a dispersion should be manufactured instead of a solution.

A starch or starch-derivative alkenylsuccinate, for example, a starch or starch-derivative octenylsuccinate, is used as an anionic starch ester. Generally the alkenyl group of the alkenyl succinate is derived from an alkene containing 3-24, particularly 3-12, carbon atoms, such as octenyl.

Alkenylsuccinate can be manufactured by making a basic material, such as starch, react with alkenylsuccinic anhydride corresponding to an ester, for example, in a water phase, when a water dispersion of alkenyl succinate will be obtained. The amount of succinic anhydride is as much as two times the mass of the starch. However, the most suitable alkenylsuccinic anhydride is 0.01-95 weight-%, preferably about 1-50 weight-% of the mass of the dry substance of the starch. Generally, the amount is 70 weight-% or less of the dry substance.

Starch esters are also suitable for use in the invention; see, for example, FI patent publication 107386.

The molecular weight and degree of substitution of the starch modificates can be used to affect their penetration into a fibre product. Setting the degree of substitution can, for its part, be used to affect the affinity between the polymer and the fibre product. The mean molecular weight is generally about 5.000-2.500.0000 g/mol.

In addition to pure products, mixtures of starch polymers, as well as of other polymers, such as commercial polyvinylalcohols, can also be used. The amount of starch modificates in such polymer mixtures is generally at least 10 weight-%, particularly their share of the total amount of the mixture is at least 50 weight-%.

A starch modificate can be spread (applied) to the surface of the substrate using conventional methods, examples of which are roll surfacing, blade coating, spray surfacing, and curtain coating. The starch modificate is typically applied in the form of a colloidal solution or a water solution.

Suitable starch derivatives and solutions made from them are described in greater detail in, for example, publication WO 2008/145827.

The polymer content in the solution being applied is generally about 0.01-30%, particularly about 0.1-20%, usually about 5-15%, calculated from the mass of the solution. However, the solids content of the starch modificate in an undiluted solution can be as much as 90 weight-%, generally about 20-90 weight-%, particularly about 30-85 weight-%.

### EXAMPLE

A solution, in which there is 16.7% PA_PO5-8 Dsaset 0,9 (100C4), and 83.3% milli-Q water, has been shown to print successfully from roll to roll using a flexographic printing technique.

Raised patterning using the roll-to-roll technique proved to be considerably cheaper than, for example, marking implemented using a pigment-based printing ink, in terms of visual effect.

Below is a more detailed description of the manufacture of the substance used in the example.

### Manufacture of Starch Derivatives

### A. Hydroxypropylized Starch Acetate (PAPO_{—}5-8, 100C4)

Hydroxypropyl starch was manufactured using the method according to patent FI 107930. The hydroxypropyl starch's molecular degree of substitution was 0.4. The hydroxypropyl starch was acetylized by mixing 13 kg hydroxypropyl starch, 10.1 kg acetic anhydride, 20.1 kg acetic acid, and 1 kg sodium acetate in a 100-1 reactor and heating the reaction mixture for 4 h at 115° C. After the reaction, the reaction mixture was poured into about 100 l of water, neutralized to a pH level of 5 with sodium hydroxide pH, and ultra-filtered (Pall UF, cut off 10000). Once the electrical conductance of the ultra-filtered solution (the part coming through the membrane) was 1.6 mS, ultra-filtering was stopped and the product was dried with a spray-dryer (lt:t 215/80). The product's degree of acetylization was DS 0.9.

Hydroxypropyl-starch acetated with different molecular degrees of substitution can be manufactured correspondingly from hydroxypropyl starch. The degree of acetylization can also be adjusted by means of the amount of acetic anhydride.

### B. Cationic Starch Acetate (7C14):

9.2 kg spray-dried cationic starch (Ciba Specialty Chemicals Oy, Raibond, DS 0.2) was mixed with 12.0 kg acetic anhydride and 6.9 kg acetic acid, as well as 0.7 kg sodium acetate in a 100-1 Drais reactor. This was mixed and gradually heated to 115° C., at which temperature it was allowed to react for 2 h. The reaction mixture was poured into 100 l water and neutralized to pH 5 with NaOH. The neutralized product was ultra-filtered (membranes cut off 9000), until the electrical conductance of the solution coming out was less than 2 mS. Ultra-filtering lasted about 124 h. The solution was spray-dried (lt:t 200/80° C.). The amount of the dried product was 7.7 kg and the degree of substitution of the acetyl groups D.S. 0.8.

C. Manufacture of Starch Acetate from Cationic Starch (7C15)

Spray-dried Raibond (Ciba Specialty Chemicals Oy, DScat 0.2), acetic anhydride, acetic acid, and sodium acetate were mixed together. The reagent amounts, calculated as dry substances were according to the recipe below.

### Recipe:

7.9 kg Raibond
18.7 kg Acetic anhydride
5.9 kg Acetic acid
0.6 kg Sodium acetate

The reaction mixture was heated to 60° C. for about 30 min and after that to 115° C. for 4 h. After this, the reaction mixture was poured into 200 l water and neutralized to pH 5 with NaOH. Ultra-filtering (membranes' cut off 9000) was used to remove salts and reagent residues from the reaction mixture. Ultra-filtering was continued, until the electrical conductance of the filtrate was <2 mS. The product was spray-dried and the degree of substitution DS acet of the product was 2.3.

1. Method for producing an optically detectable marking on a substrate, in which method comprises the steps of;
providing a substrate,
printing ink containing starch derivative in a solution form on at least a selected first area of the surface of the substrate and leaving at least a selected second area unprinted,
drying the printing ink, in such a way that the starch derivative forms a thermoplastic film in the said first area of the surface of the substrate,
hot-pressing an optically detectable marking onto the film.

2. Method according to claim 1, in which an amount of starch derivative is printed, which is sufficient to form a unified film on the surface of a fibre product.

3. Method according to claim 1, in which starch-ether esters, anionic starch esters, or starch ethers or esters are used as the starch derivative.

4. Method according to claim 1, in which the printing is performed using a multi-colour printing press.

5. Method according to claim 1 in which the hot-pressing is performed using a roller, which comprises micro-structures, so that the micro-structures are reproduced only in the said first area, but not in the said second area.

6. Method according to claim 1, in which hot-pressing is performed at a temperature, which is at least 50° C.

7. Method according to claim 1, in which the optically detectable marking comprises a diffractive visually detectable pattern.

8. Method according to claim 1, in which paper or board is used as the substrate.

9. Method according to claim 1, in which a starch acetate is used as the starch derivative.

10. Method according to claim 1, in which printing is implemented using an offset, gravure, flexographic, serigraphic, or inkjet printing technique.

11. Paper or board product, which comprises
a fibre-based substrate,
a unified, thermoplastic polymer film, comprising a starch derivative, in at least a first area on the surface of the substrate,
at least one second area, which is on the substrate and is free of the thermoplastic polymer film comprising a starch derivative,
an optically detectable embossing manufactured in the thermoplastic polymer film in the first area.

12. Product according to claim 11, in which the marking covers a polymer film covering the entire first area.

13. Product according to claim 11, in which the marking is diffractive embossing.

14. Product according to claim 11, in which the starch derivative is a starch acetate.

15. Product according to claim 11, in which the content of the starch derivative in the film is at least 10%.

16. Product according to claim 11, in which the first area is printed using an offset, gravure, flexographic, serigraphic, or inkjet printing technique.
